(19) United States
(12) Patent Application Publication
(10) Pub. No.: US 2023/0018219 A1
(43) Pub. Date: Jan. 19, 2023

(54) HYDRAULIC CONTROL SYSTEM FOR A VARIABLE COMPRESSION RATIO ENGINE

(71) Applicant: MCE 5 Development, Villeurbanne (FR)

(72) Inventors: René-Pierre Bertheau, Amberieux-en-Dombes (FR); Sylvain Bigot, Pau (FR); Xavier Chemin, Eguilles (FR)

(21) Appl. No.: 17/756,952

(22) PCT Filed: Dec. 4, 2020
(86) PCT No.: PCT/FR2020/052280

§ 371 Date: Jun. 6, 2022

(30) Foreign Application Priority Data
Dec. 5, 2019 (FR) FR1913798

(51) Int. Cl. F02D 15/02; F02B 75/04

(52) U.S. Cl. CPC F02D 15/02; F02B 75/045

(57) ABSTRACT

A hydraulic control system for a variable compression ratio engine, comprises: a control cylinder comprising a piston, a body in which two hydraulic chambers with equivalent sections are defined on either side of the piston and a return device arranged in one of the chambers, a hydraulic control circuit comprising: at least one duct connecting the two chambers to each other, and a controlled fluid discharging device for establishing or blocking a fluid communication between the chambers, at least one duct connecting one of the chambers to a low-pressure oil supply, and a refill valve, at least one duct connecting an oil outlet to at least one of the chambers, and a relief valve.

### CROSS-REFERENCE TO RELATED APPLICATIONS

This application is a national phase entry under 35 U.S.C. § 371 of International Patent Application PCT/FR2020/052280, filed Dec. 4, 2020, designating the United States of America and published as International Patent Publication WO 2021/111088 A1 on Jun. 10, 2021, which claims the benefit under Article 8 of the Patent Cooperation Treaty to French Patent Application Serial No. FR1913798, filed Dec. 5, 2019.

### TECHNICAL FIELD

The present disclosure relates to the field of variable compression ratio engines. It relates, in particular, to a hydraulic system for controlling the ratio, supplied by the lubrication circuit of the engine, which system is provided with an independent means for pressurizing the oil ensuring an average hydraulic pressure in the hydraulic control circuit that is continuously greater than the engine lubrication pressure during engine operation.

### BACKGROUND

Variable compression ratio engines are known, the control system for the ratio of which, operating individually for each combustion cylinder, is based on a hydraulic cylinder. Examples include the continuous ratio VCRi engine and the so-called bi-ratio connecting rod systems developed, in particular, by the companies FEV or AVL.

The known advantage of using a hydraulic system to control the ratio is that large forces can be transferred to small dimensions through hydraulic pressure. Thus, a VCRi engine operates at pressures of up to 300 bars, while bi-ratio connecting rod systems can operate at pressures of up to over 2000 bars.

The power transmission system of any engine is subject to alternating forces. This alternation of forces naturally applies to the hydraulic control system, which will undergo forces ranging from a maximum pressure, usually defined by the maximum combustion pressure encountered, to a minimum pressure, defined by the inertia forces encountered at top dead center.

Oil is a compressible fluid, especially since it is loaded with gas (motor oil is conventionally aerated between 5% and 30% depending on operating conditions). This elasticity, measured by the isostatic modulus of elasticity (otherwise called bulk modulus), results in a modification of the position of the control cylinder according to the force applied, which causes oscillations in the system, leads to an amplification of the forces by dynamic effect, and harms the precision desired for the control of the compression ratio. To minimize these negative effects, it is desirable to use the least flexible oils possible, that is to say, having the highest possible bulk modulus.

It is known (see the curve in FIG. 1) that the bulk modulus (K_{E}) of an oil (a, b, c, d, e) increases with the pressure (p), then stabilizes from a certain pressure level. It is therefore advantageous, in order to improve the precision of the rate adjustment, to operate in pressure ranges that are above the stabilizing pressure of the bulk modulus, i.e., about 30 bars for engine oil.

For economic reasons, it is generally desired to use the lubrication circuit of the engine to ensure pressurization of the control system; however, the latter operates at pressures of 2 to 6 bars, which is well below the stabilizing pressure of the isostatic modulus of elasticity. To gain precision, and to limit the dynamic amplifications of the forces to which the control system is subjected, it is therefore necessary to increase the oil pressure in the system.

Document WO2018/158539 proposes adding a hydraulic pump to the low-pressure circuit to increase the average pressure in the control system beyond the stabilizing pressure of the oil bulk modulus, as well as a valve between the outlet of the hydraulic pump and the control system, allowing this pressure to be further increased depending on the usage conditions of the engine.

The company FEV (“2-step variable compression ratio system development & industrialization,” 2^{nd} International FEV Conference, Feb. 7-8, 2019) proposes to use a particular distributor to ensure the pressure increase in the hydraulic chamber of the control system, by pumping effect. In such a configuration, a ratio change, which will result in the opening of the distributor, will cause the pressure in the control system to drop to the supply pressure (lubrication circuit): this implies that the isostatic modulus of elasticity of the oil will not be optimal at least for a few cycles, which can lead to temporary overloads of the kinematics (amplification phenomena due to impacts).

Document JP2003/322036 proposes a mechanism for a variable compression ratio engine comprising electrical means for controlling the rotation of the control shaft and hydraulic holding means making it possible to reduce the forces applied to the control means and avoiding continuously supplying them with energy.

Document FR2914951 proposes an electrohydraulic closed-loop control device for a control cylinder of a variable compression ratio engine.

### BRIEF SUMMARY

The present disclosure provides an alternative solution to those in the prior art, addressing all or some of the aforementioned drawbacks. It relates, in particular, to a hydraulic control system comprising a control cylinder and a hydraulic control circuit, and the architecture of which allows the average pressure in the hydraulic chambers of the control cylinder to be increased to values greater than the lubrication pressure, and typically greater than 20 bars, and allows the average pressure to be maintained during changes in engine compression ratio.

The present disclosure relates to a hydraulic control system for a variable compression ratio engine, comprising:
a control cylinder comprising a piston and a body in which two hydraulic chambers with equivalent sections are defined on either side of the piston, the piston being able to move in the body to control the compression ratio of the engine,
a hydraulic control circuit comprising at least one duct connecting the two hydraulic chambers to each other, and a controlled fluid discharging device for establishing or blocking a fluid communication between the chambers,

The hydraulic control system is remarkable in that:
the hydraulic control circuit comprises:
* at least one duct connecting at least one of the hydraulic chambers and a low-pressure oil supply, and a first non-return valve, to refill the hydraulic control circuit when the pressure in the hydraulic chamber drops below the low pressure, due to combustion and/or engine inertia forces applied to the cylinder,
* at least one duct connecting an oil outlet and at least one of the hydraulic chambers, and a relief valve for draining the hydraulic control circuit when the pressure in the hydraulic chamber exceeds a determined maximum pressure,
the control cylinder comprises a return device tending to bring the cylinder back to a length corresponding to a maximum compression ratio of the engine.

The hydraulic control system according to the present disclosure makes it possible to supply the hydraulic control circuit by means of a low-pressure oil supply, typically connected to the lubrication circuit of the engine (low pressure, between 2 and 6 bars, for example), owing to the duct connecting at least one of the hydraulic chambers and a low-pressure oil supply. It also allows the average pressure in the hydraulic chambers of the control cylinder to be increased to values higher than the lubrication pressure, and typically higher than 20 bars, due to the presence of the first non-return valve, which allows the hydraulic circuit to be refilled when the combustion and/or inertia forces applied to the cylinder sequentially cause pressure drops in the chamber connected to the supply.

The hydraulic control system according to the present disclosure makes it possible to maintain this average pressure, typically greater than 20 bars, in the hydraulic chambers during the ratio change operation. Indeed, the presence of the first refill non-return valve prevents the hydraulic control circuit from dropping back down to the low supply pressure, by isolating it from the supply irrespective of the operating conditions of the engine. The change in ratio, linked to the displacement of the piston in the body of the control cylinder, is defined by the controlled fluid discharging device, which manages the circulation and the transfer of oil from one chamber to the other, and thus the piston position.

This improves ratio setting accuracy, since the hydraulic control system operates in pressure ranges above the bulk modulus stabilizing pressure.

In addition, the hydraulic control system according to the present disclosure makes it possible to regulate the average pressure in the hydraulic chambers and allows the effective achievement of variable compression ratios between the minimum ratio and the maximum ratio, as well as an effective ratio change, that is to say, with a good dynamic, between the minimum ratio and the maximum ratio, or vice versa.

According to other advantageous and non-limiting features of the present disclosure, taken individually or in any technically feasible combination:
the duct fitted with the relief valve connects the oil outlet and the chamber, among the two hydraulic chambers, that is not subjected to the combustion forces of the engine,
the return device is arranged in the chamber, among the two hydraulic chambers, that undergoes engine combustion forces,
the hydraulic control circuit is carried by the body of the control cylinder;
the controlled fluid discharging device is actuated by an electrical control circuit;
the controlled fluid discharging device is actuated by a hydraulic control circuit;
the fluid discharging device comprises a two-position controlled shutter, one position of which blocks fluid communication between the two chambers and the other position allows fluid communication between the two chambers, in both directions of circulation;
the hydraulic control circuit comprises at least two ducts connecting the two hydraulic chambers to each other, and in which the fluid discharging device comprises two controlled shutters with two positions and two oriented valves, a first shutter and a first oriented valve being carried by a first duct, to block or authorize the circulation of oil from the first chamber to the second chamber, and a second shutter and a second oriented valve being carried by a second duct, to block or authorize the circulation of oil from the second chamber to the first chamber;
each controlled shutter is arranged along a transverse axis, normal to a longitudinal movement axis of the piston in the body of the control cylinder;
the piston of the control cylinder is intended to be connected to a return member of a mobile coupling of the engine, and the body of the control cylinder is intended to be connected to a stationary part of the engine.

### BRIEF DESCRIPTION OF THE DRAWINGS

Other features and advantages of the present disclosure will become apparent from the following detailed description of the present disclosure, with reference to the accompanying drawings, in which:

FIG. 1 shows a curve relating the isostatic modulus of elasticity of oils to the pressure;

FIG. 2 shows a block diagram of a hydraulic control system according to a first embodiment, in accordance with the present disclosure;

FIGS. 3a and 3b, respectively, show a block diagram of a hydraulic control system according to a second embodiment, in accordance with the present disclosure, and different options for the position at rest of the fluid discharging device in a hydraulic control system according to the second embodiment;

FIGS. 4a and 4b show curves illustrating the operation of a control system according to the state of the art, with pressure drop upon each ratio change and, respectively, without and with oil replenishment of the hydraulic control system;

FIG. 5 shows curves illustrating the operation of a control system in accordance with the present disclosure;

FIGS. 6a, 6b, 6c, 6d, 6e show a particular example embodiment of the hydraulic control system, according to the second embodiment of the present disclosure;

FIG. 7 shows a movable coupling and variable compression ratio control system in a prior art engine;

FIG. 8 shows a side view of a movable coupling and hydraulic control system for a variable compression ratio engine, the system being in accordance with the present disclosure.

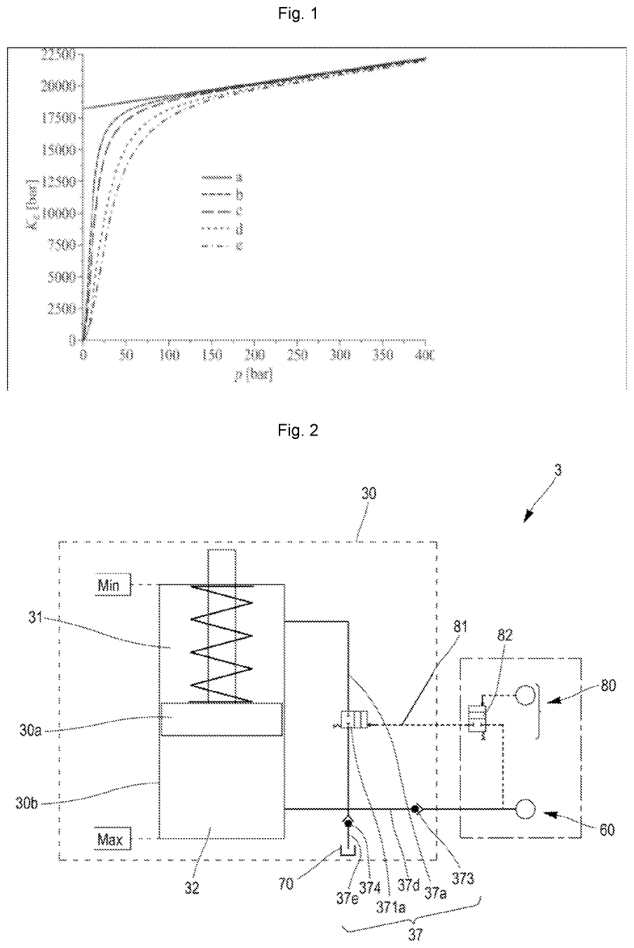

### DETAILED DESCRIPTION

In the descriptive part, the same references in the figures may be used for the same type of elements or elements with the same function. Some figures are schematic representations that, for the sake of readability, are not necessarily to scale and do not necessarily reflect all the practical implementation constraints.

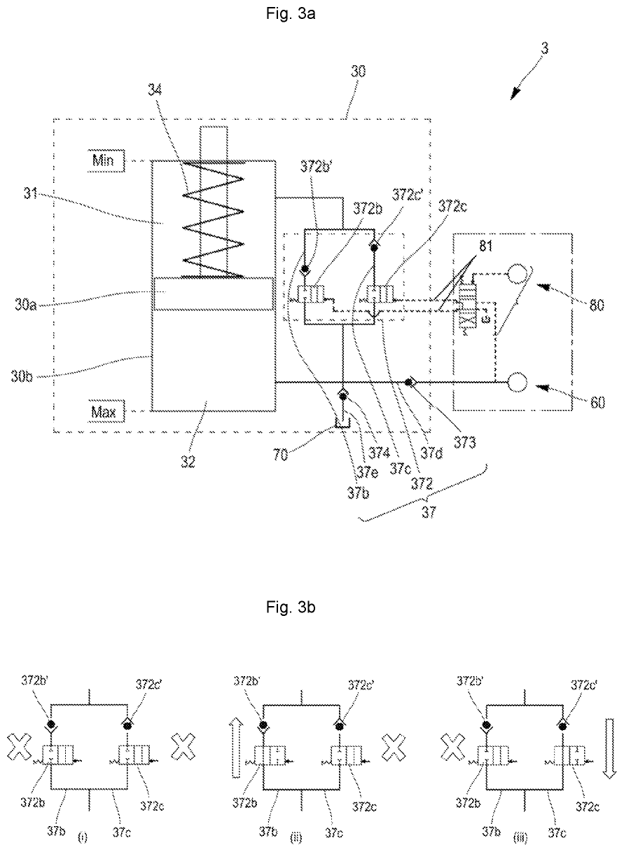

The present disclosure relates to a hydraulic control system 3 for a variable compression ratio engine, two embodiments of which are illustrated in FIG. 2 and in FIG. 3a, respectively.

The control system 3 according to the present disclosure comprises a control cylinder 30 comprising a piston 30a and a body 30b in which two hydraulic chambers 31, 32 with equivalent sections are defined on either side of the piston 30a. Note that FIGS. 2 and 3a are schematic and do not illustrate the equivalent nature of the sections of the two chambers 31, 32. The piston 30a is able to move in the body 30b, which modifies the length of the cylinder and defines (or in other words, controls) the compression ratio of the engine.

It is understood that such a control system 3 could be integrated into a connecting rod of variable length, directly connected to the combustion piston and to the crankshaft of a variable combustion ratio engine. It may also be integrated into a VCRi-type control cylinder. Finally, as will be described in more detail in an example below, such a control system 3 could be integrated into an engine of the VC-T (variable compression-turbo) type as described in document EP2787196.

The hydraulic control system 3 also comprises a hydraulic control circuit 37 whose role is, in particular, to supply the hydraulic chambers 31, 32 of the control cylinder 30 with oil and to manage the transfer of oil from one chamber to the other.

To this end, the hydraulic control circuit 37 comprises at least one duct 37a, 37b, 37c connecting the two hydraulic chambers 31, 32 to each other. Subsequently, this or these duct(s) 37a, 37b, 37c will be called transfer ducts 37a, 37b, 37c because they allow the circulation of oil from one chamber 31, 32 to another. The hydraulic control circuit 37 also comprises a fluid discharging device 371a, 372 arranged on the (at least one) transfer duct 37a, 37b, 37c, between the two hydraulic chambers 31, 32. The fluid discharging device 371a, 372 is controlled to establish or block fluid communication between the chambers 31, 32; in other words, the device 371a, 372 is controlled to open or close the duct(s) 37a, 37b, 37c connecting the two chambers 31, 32. This implies the presence of a control circuit 80, connected to the fluid discharging device 371a, 372; the control circuit 80 will be described later. The transfer ducts 37a, 37b, 37c and the fluid discharging device 371a, 372 make it possible to manage the transfer of oil from one hydraulic chamber 31, 32 to another, and thus to modify the length of the control cylinder 30, corresponding to a change in the engine compression ratio.

The hydraulic control circuit 37 also comprises at least one duct 37d connecting at least one of the hydraulic chambers 31, 32 to a low-pressure oil supply 60. A first non-return valve 373 is arranged on the duct 37d: it only allows oil to pass from the oil supply 60 to the hydraulic chamber 31, 32 when the pressure in the hydraulic chamber drops below the oil supply pressure. In practice, the oil pressure from the oil supply 60 is between 2 and 6 bars. Because the duct 37d and the first non-return valve 373 allow the hydraulic control circuit 37 to be refilled with oil, they may, respectively, be referred to hereinafter as refill duct 37d and refill valve 373.

Advantageously, since the control cylinder 30 of the system 3 according to the present disclosure is intended to undergo the inertial and combustion forces of the engine, the refill duct 37d and the refill valve 373 are arranged between the oil supply 60 and the one of the two hydraulic chambers 32 that is not subjected to the combustion forces of the engine. Since the forces generated by the combustion are greater than those generated by the inertias, the hydraulic chamber 32 will experience the greatest depression and the lowest instantaneous pressure, thus improving the replenishment.

The hydraulic control circuit 37 allows the average pressure in the hydraulic chambers 31, 32 of the control cylinder 30 to be increased to values greater than the lubrication pressure (low pressure), and typically greater than 20 bars, or even greater than 30 bars. This is made possible by the presence of the refill valve 373, which authorizes the introduction of oil into the hydraulic control circuit 37, when the combustion and/or inertia forces applied to the cylinder 30 sequentially cause pressure drops in the chamber connected to the supply.

In addition, the hydraulic control circuit 37 according to the present disclosure makes it possible to maintain this average pressure, typically greater than 20 bars, in the hydraulic chambers 31, 32 during the ratio change operation. Indeed, the refill valve 373 prevents the hydraulic control circuit 37 from dropping back down to the low supply pressure, by isolating it from the supply, irrespective of the operating conditions of the engine. The change in ratio, linked to the displacement of the piston 30a in the control cylinder 30, is defined by the controlled fluid discharging device 371a, 372 that manages the circulation and the transfer of oil from one chamber to the other, and thus the position of the piston 30a in the body 30b of the control cylinder 30.

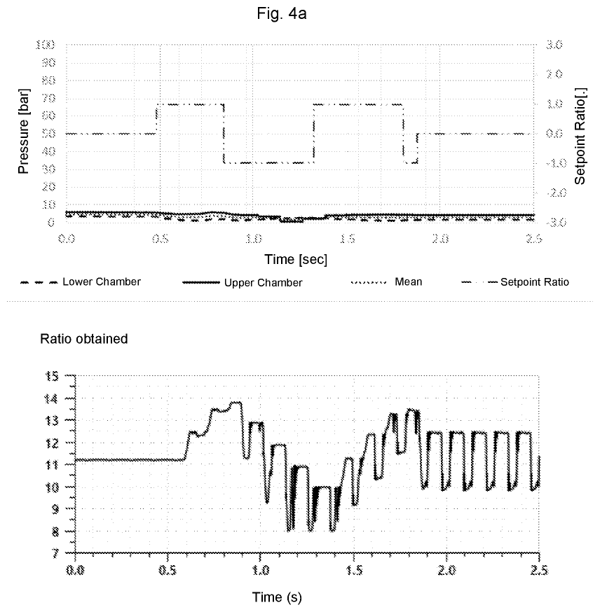

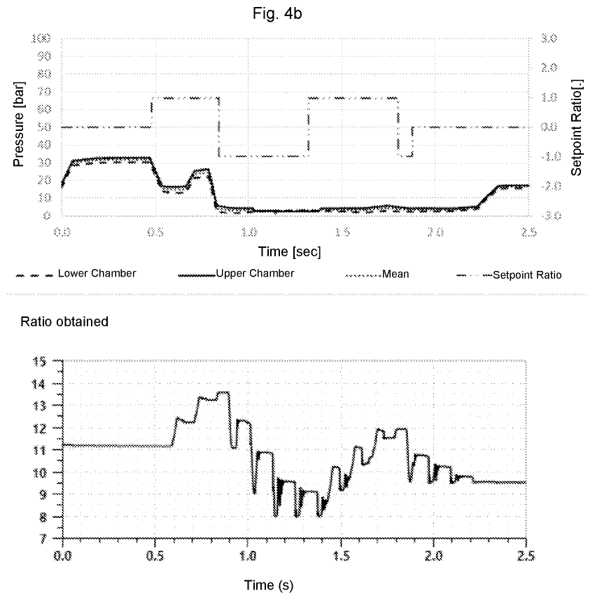

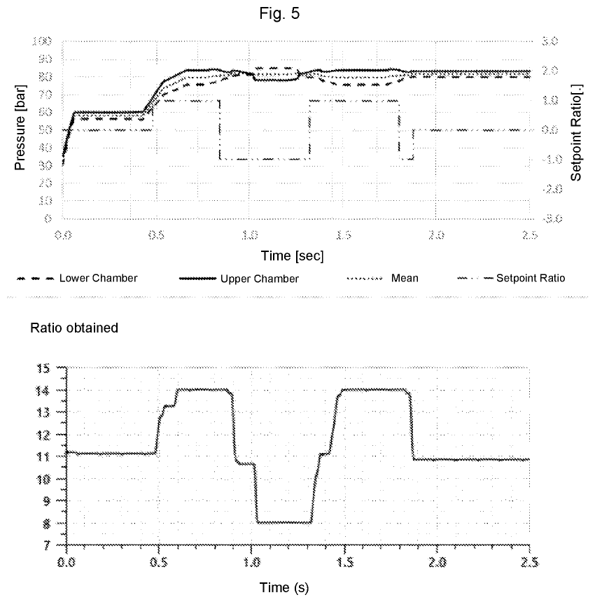

The precision of the adjustment of the length of the control cylinder 30, and therefore the adjustment precision of the compression ratio, are improved because the hydraulic control system 3 operates in average pressure ranges lying above the stabilizing pressure of the bulk modulus. This appears clearly by comparing the curves of FIGS. 4a, 4b and 5. FIGS. 4a, 4b illustrate the operation of a hydraulic control system close to the state of the art, that is to say, undergoing a loss of pressure during changes in the compression ratio; in FIG. 4a, the system has no oil replenishment function, whereas in FIG. 4b, the system is provided with one. FIG. 5 illustrates the operation of a hydraulic control system in accordance with the present disclosure, not undergoing a loss of pressure during changes in compression ratio and comprising a function of replenishing the hydraulic chambers 31, 32 with oil.

Both cases involve conditions of engine speed at 1000 revolutions per minute and a maximum pressure in the combustion cylinder of 32 bars. The average pressure in the hydraulic chambers is calculated over one engine cycle (0.12 s). The rate setpoint is defined as follows: +1 requests an increase in the compression ratio, 0 requests a fixed ratio, −1 requests a decrease in the compression ratio.

In FIG. 4a, the average pressure in the hydraulic chambers always remains below 10 bars. For a defined setpoint, the real compression ratio obtained oscillates very strongly, typically by more than two points, which makes servo-control impossible. In FIG. 4b, the average pressure in the hydraulic chambers can reach values greater than 20 bars in a certain control phase but drops with each change in compression ratio. Here again, for a defined setpoint, the real compression ratio obtained oscillates strongly and takes time to stabilize, which makes servo-control difficult.

In FIG. 5, the average pressure in the hydraulic chambers 31, 32 increases during the first engine cycles and remains greater than 20 bars, or even greater than 30 bars, during compression ratio change operations. For the same ratio setpoint as previously, the compression ratio obtained is much more stable (no or few oscillations) and precise. The hydraulic control system 3 according to the present disclosure therefore shows very good performance, even at an operating point with very little load (low engine speed, idle).

The observation is similar when placed under higher engine speed conditions, typically at 4000 revolutions per minute, with a maximum pressure in the combustion cylinder of 67 bars.

The hydraulic control circuit 37 further comprises at least one duct 37e connecting at least one of the hydraulic chambers 31, 32 to an oil outlet 70. A second non-return valve 374 is arranged on the duct 37e and allows the hydraulic control circuit 37 to be drained when the pressure in the hydraulic chamber 31, 32 exceeds a determined maximum pressure due to combustion and/or inertia forces of the engine applied to the cylinder (30). The duct 37e and the second non-return valve 374 may be referred to below, respectively, as the outlet duct 37e and the outlet valve 374. They prevent the average pressure in the hydraulic chambers 31, 32 from being too high and imposing complex sealing solutions in the control cylinder 30. In other words, they make it possible to regulate the average pressure in the hydraulic chambers 31, 32. It is favorable to connect the outlet duct 37e to the hydraulic chamber 32 that is not subjected to the combustion forces of the engine (as illustrated in the examples of FIGS. 2 and 3a) for better regulation of the average pressure, since the overpressures in the chamber 32 are lower than those in the chamber 31 undergoing the combustion forces.

Note that the hydraulic control system 3 could nevertheless operate with a hydraulic control circuit 37 devoid of outlet duct 37e and outlet valve 374: the particularity of having hydraulic chambers 31, 32 with equivalent sections allows the control and governing of the system 3, irrespective of the average pressure in the chambers 31, 32. This average pressure would increase to a stabilization level corresponding to stopping of the replenishment function (i.e., when the instantaneous pressure in the hydraulic chamber(s) 31, 32 connected to the oil supply 60 via the duct 37d and the refill valve 373 no longer passes below the supply pressure). However, depending on the operating points, the average stabilized pressure could be high, typically greater than 500 bars, and would require sealing adapted to the maximum instantaneous pressure levels attainable in the hydraulic chambers 31, 32.

Advantageously, the hydraulic control circuit 37 is carried by the body 30b of the control cylinder 30. In practice, the ducts 37a, 37b, 37c, 37d, 37e are arranged by drilling in the body 30b; the fluid discharging device 371a, 372 and the first and second non-return valves 373, 374 are integrated into the body 30b. The oil supply 60 is external to the control cylinder 30; it is typically connected to the lubrication circuit of the engine.

Finally, the control cylinder 30 comprises a return device 34, tending to bring the cylinder 30 back to a length corresponding to the maximum compression ratio. Note that depending on the location of the control cylinder 30 in the engine, the maximum compression ratio may correspond to its minimum or maximum length. At low speed, the combustion forces exerted on the control cylinder 30 (tending to bring the system to the minimum ratio) are greater than the inertia forces (tending to bring the system to maximum ratio). Due to the equivalent sections, it is therefore easier for the control cylinder 30 to move into its position corresponding to the minimum ratio than into its position corresponding to the maximum ratio, since there is potentially more effort to do so. The return device 34 allows an additional force (in addition to the inertial forces) to be exerted to increase the speed of change in length of the cylinder 30 toward the maximum ratio and thus not to penalize fuel consumption and pollution emissions. As illustrated in the examples of FIGS. 2 and 3a, the return device 34 is arranged in the hydraulic chamber 31 that undergoes the combustion forces of the engine.

Owing to the return device 34, the hydraulic control system 3 according to the present disclosure therefore allows the effective achievement of the variable compression ratios between the minimum ratio and the maximum ratio, as well as an effective ratio change, that is to say, with a good dynamic, between the minimum ratio and the maximum ratio, and vice versa.

The return device 34 (for example, a spring) is typically sized to bring the control cylinder 30 from the position (length) corresponding to a minimum compression ratio to the position corresponding to a maximum compression ratio in less than 2 seconds, under engine speed conditions at about 1000 revolutions per minute. This sizing takes into account the pre-load and the stiffness of the return device 34, in line with the pressure drop calibration of the transfer duct(s) 37a, 37b, 37c connecting the two hydraulic chambers 31, 32 to each other. Of course, the return device 34 must also allow the change in ratio toward the minimum compression ratio, by the combustion forces, with an acceptable dynamic, typically in less than 0.5 to 0.8 seconds, under engine speed conditions at approximately 1000 revolutions per minute (rpm).

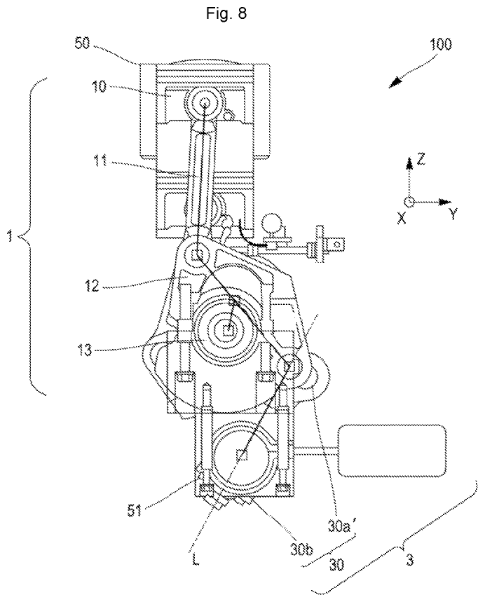

By way of example, consider a hydraulic control system 3, designed for a variable compression ratio engine (100), of the type illustrated in FIG. 8, and the kinematics of which leads to a maximum force at the end of the control cylinder 30 of 31 kN at 1500 rpm for a pressure in the combustion cylinder of 120 bar, and 10 kN for a combustion pressure of 55 bar. At 5500 rpm, these forces become 40 kN for a combustion pressure of 120 bar, and 15 kN for a combustion pressure of 55 bar. The diameter of the piston 30a is chosen at 47 mm to limit the pressure in the control cylinder 30 at maximum effort. To ensure a return to the maximum compression ratio position at low speed, the spring 34 has a preload of 200 N, and a stiffness of 50 N/mm.

A calibrated 2 mm orifice between the two hydraulic chambers 31, 32, located on the transfer duct 37c, allows, in this configuration, a speed of variation from the maximum ratio to the minimum ratio of 0.35 s at 1500 rpm, and 0.17 s at 5500 rpm. A calibrated 1 mm orifice, located on the duct 37c, allows a ratio variation speed of 0.84 s at 1500 rpm, and 0.53 s at 5500 rpm.

To change the ratio from the minimum compression ratio to the maximum compression ratio, the configuration described above, with a 2 mm orifice located on the transfer duct 37b, leads to a rate of rise from the minimum ratio to the maximum ratio of 1.13 s at 1500 rpm, and of 0.37 s at 5500 rpm, while a 1 mm hole, located on the duct 37b, allows a speed of variation from the minimum ratio to the maximum ratio of 1.9 s at 1500 rpm and 0.67 s at 5500 rpm.

This example illustrates the impact of the configuration of the hydraulic control circuit 37 on the dynamics of the control system 3. It may be noted that increasing the stiffness of the return device 34, or its preload, would have led to different deviations between the ratio change times at low rpm and at high rpm, and would also have required other calibrated orifice diameters on the ducts 37a, 37b, 37c in the hydraulic control circuit 37.

According to the first embodiment illustrated in FIG. 2, the fluid discharging device 371a comprises a two-position controlled shutter, one position of which blocks fluid communication between the two chambers 31, 32 and the other position allows fluid communication between the two chambers 31, 32, in both directions of circulation.

This first embodiment is based on synchronous operation of the hydraulic control system 3, that is to say, the control of the fluid discharging device 371a must be synchronized with the engine cycles. For example, to move the piston 30a toward the maximum length of the cylinder 30 (corresponding, for example, to a minimum compression ratio), it is necessary to allow fluid communication between the chambers 31, 32 when the combustion forces and/or inertia tend to increase the pressure in the first chamber 31 (or upper chamber in FIG. 2), which will cause a transfer of oil from the first chamber 31 to the second chamber 32 (or lower chamber); it is sequentially necessary to block the fluid communication between the chambers 31, 32 when the combustion and/or inertia forces tend to increase the pressure in the lower chamber 32, so as to avoid transferring oil from the lower chamber 32 to the upper chamber 31. The opposite principle must be implemented to move the piston 30a toward the minimum length of the cylinder 30 (corresponding, for example, to a maximum compression ratio of the engine).

In this first embodiment, the controlled fluid discharging device 371a must be compatible with a very short switching time, typically 1 ms. An electrohydraulic shutter, directly implanted in the body of the cylinder 30, could fulfill this function and would require a wired connection between the mobile cylinder 30 and a stationary engine control. A purely hydraulic fluid discharging device, as illustrated in FIG. 2, is also possible. In this case, it is necessary to take into account a time delay for the actuation of the device 371a, due to the oil duct connecting the control circuit 80 of the device.

According to the second embodiment illustrated in FIG. 3a, the hydraulic control circuit 37 comprises at least two transfer ducts 37b, 37c connecting the two hydraulic chambers 31, 32 to each other. The fluid discharging device 372 comprises two controlled shutters 372b, 372c with two positions, and two oriented valves 372b′, 372c′. A first shutter 372b and a first oriented valve 372b′ are carried by a first transfer duct 37b, to block or authorize the circulation of oil from the second chamber 32 (or lower chamber in FIG. 3) toward the first chamber 31 (or upper chamber). A second shutter 372c and a second oriented valve 372c′ are carried by a second transfer duct 37c, to block or authorize the circulation of oil from the first chamber 31 toward the second chamber 32. In this embodiment, it may be advantageous to calibrate the pressure drop of each duct connecting the two hydraulic chambers so as to manage the movement speed of the control cylinder 30.

This second embodiment is based on an asynchronous operation of the hydraulic control system 3, that is to say, the control of the fluid discharging device 372 is independent of the engine cycles.

For example, to move the piston 30a toward the maximum length of the cylinder 30 (corresponding, for example, to a minimum compression ratio of the engine), the first shutter 372b allows fluid communication between the chambers 31, 32, while the second shutter 372c blocks fluid communication. Thus, when the combustion and/or inertia forces tend to increase the pressure in the upper chamber 31, a transfer of oil takes place from the upper chamber 31 to the lower chamber 32; the progressive filling (with the alternation of the engine cycles) of the lower chamber 32 and the progressive emptying of the upper chamber 31 lead to the displacement of the piston 30a, toward the maximum length of the control cylinder 30.

To move the piston 30a toward the minimum length of the cylinder 30 (corresponding, for example, to a maximum compression ratio of the engine), the second shutter 372c is placed in a position allowing fluid communication between the chambers 31, 32, while the first shutter 372b is placed in a position blocking fluid communication. A transfer of oil only from the lower chamber 32 to the upper chamber 31 can thus occur; the progressive filling (with the alternation of the engine cycles) of the upper chamber 31 and the progressive emptying of the lower chamber 32 lead to the displacement of the piston 30a, toward the minimum length of the control cylinder 30.

In this second embodiment of the present disclosure, the position of each shutter 372b, 372c at rest (that is to say, without actuation by the control circuit 80) can be chosen in different ways, according to the preferred strategy in case of failure of the control circuit 80.

According to a first option (FIG. 3b (i)), the two shutters 372b, 372c at rest block any fluid communication, which freezes the compression ratio at its value in the event of failure of the control circuit 80.

According to a second option (FIG. 3b (ii)), the shutter 372b in its rest position allows fluid communication from the lower chamber 32 to the upper chamber 31, while the shutter 372c in its rest position blocks fluid communication in the opposite direction. In the event of failure of the control circuit 80, the length of the control cylinder 30 will gradually vary toward its minimum length. If this minimum length corresponds, for example, to a maximum compression ratio, this option ensures the best output and the best efficiency of the engine, limiting the pollution caused, but this reduces the usage range of the engine (limitation in speed and/or load).

According to a third option (FIG. 3b (iii)), the shutter 372c in its rest position allows fluid communication from the upper chamber 31 to the lower chamber 32, while the shutter 372b in its rest position blocks fluid communication in the opposite direction. In the event of failure of the control circuit 80, the length of the control cylinder 30 will gradually vary toward its maximum length. If this maximum length corresponds, for example, to a minimum compression ratio, this option makes it possible to maintain engine performance (no speed and/or load limitation), but reduces its efficiency and output, which increases the pollution produced by the engine.

Returning to the description of the control circuit 80 whose role is to control the fluid discharging device 371a, 372 of the control system 3, two variants are proposed.

According to a first variant of the hydraulic control system 3 applying to any embodiment of the present disclosure, the controlled fluid discharging device 371a, 372 is actuated by an external electrical control circuit. In this case, an electric wire must connect a stationary part of the engine, in which the electrical control circuit is located, and the fluid discharging device 371a, 372, preferably integrated into the control cylinder 30, which constitutes a moving part in the engine.

According to a second variant of the hydraulic control system 3 applying to any embodiment of the present disclosure, the controlled fluid discharging device 371a, 372 (which is included in the hydraulic control circuit 37) is actuated by a hydraulic control circuit 80. In other words, the fluid discharging device 371a, 372 is switched from an on position to an off position (and vice versa) by means of the pressure of a fluid from the hydraulic control circuit 80. This fluid can be water, gas or oil.

The first and second embodiments of the present disclosure shown, respectively, in FIGS. 2 and 3a illustrate a hydraulic control circuit 80 essentially external to the control cylinder 30. At least one fluid channel 81 connects the fluid discharging device 371a, 372 to the control circuit 80. The latter may, for example, comprise an electrically actuated control valve 82 making it possible to deliver a fluid pressure in the fluid channel 81 or to block the inflow of fluid into the fluid channel 81, to switch the fluid discharging device 371a, 372, respectively, into one or other of its positions.

Advantageously, the control valve 82 is connected to the engine lubrication circuit; the fluid is then low-pressure oil.

Note that the fluid discharging device 371a, 372 can be controlled, therefore actuated, directly by the fluid pressure from the control circuit 80: it will then be necessary for the fluid channel 81 to allow direct communication between the control fluid and the device 371a, 372. Alternatively, the fluid discharging device 371a, 372 may be actuated mechanically, by a force exerted by a mechanical actuating element, the latter being moved by the fluid pressure from the control circuit 80.

Advantageously, in the second variant of the hydraulic control system 3, each controlled shutter 371a, 372b, 372c of the fluid discharging device 371a, 372 is arranged along a transverse axis T, normal to a longitudinal axis L of displacement of the piston 30a in the body 30b of the control cylinder 30. A shutter 371a, 372b, 372c could, for example, be formed by a linear hydraulic slide valve whose central axis is parallel to the transverse axis T. This orientation prevents the shutter 371a, 372b, 372c from being subjected to the inertia and/or combustion forces applied to the control cylinder 30, forces that could interfere with the control forces necessary for the actuation of the shutters.

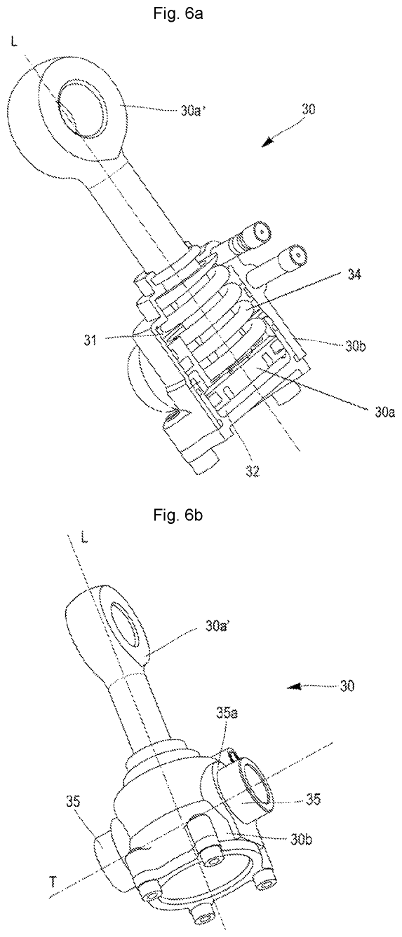

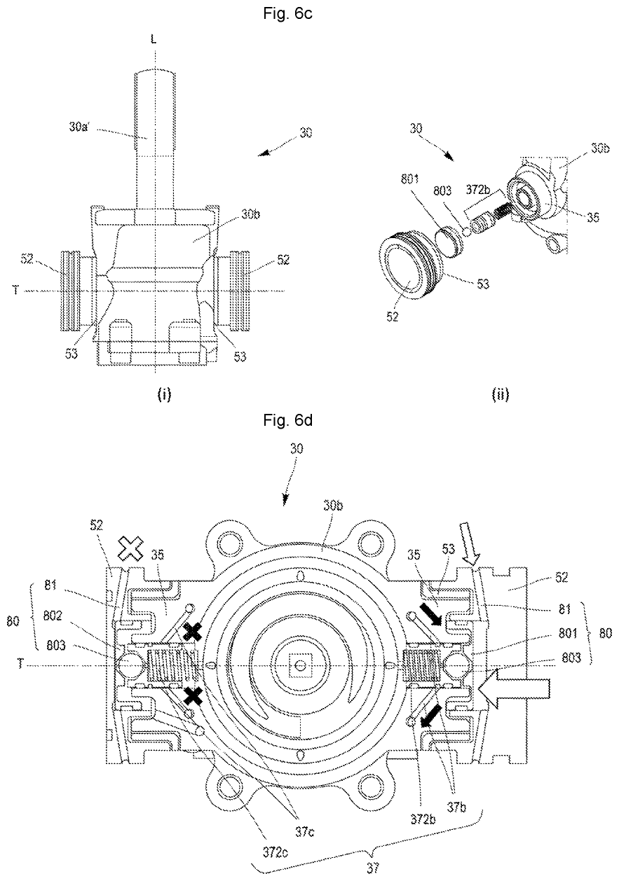

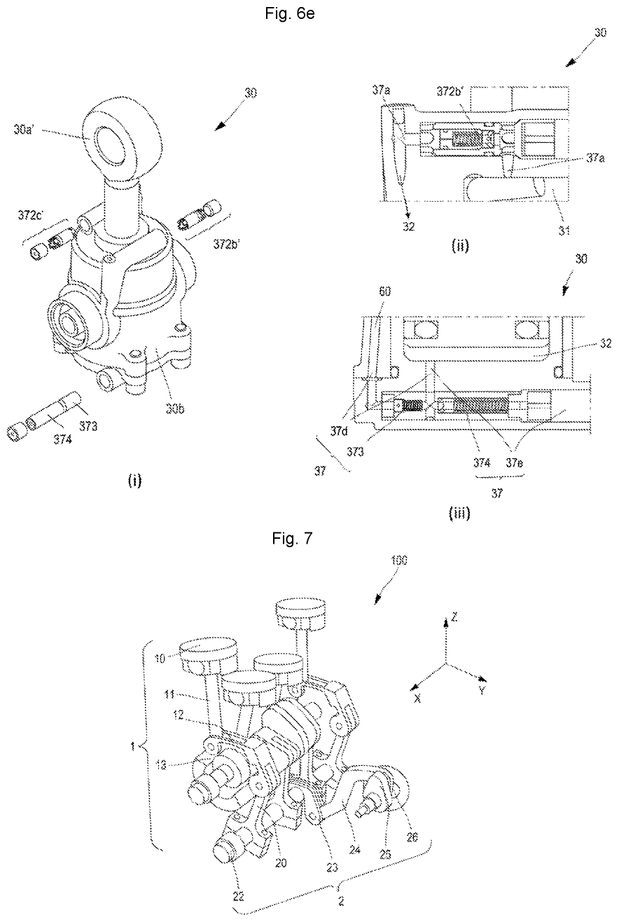

A particular example embodiment of the hydraulic control system 3 will now be described with reference to FIGS. 6a to 6e. This example is based on the second embodiment previously described, that is to say, involving a fluid discharging device 372 comprising two controlled shutters 372b, 372c and two oriented valves 372b′, 372c′. It is also based on controlling the fluid discharging device 372 by mechanical actuation.

FIG. 6a shows the control cylinder 30, with its piston 30a movable in the body 30b. The piston 30a is extended by a foot 30a′ extending beyond the body 30b along a longitudinal axis L, and capable of establishing a pivot connection with a moving element of the engine.

A first chamber 31 and a second chamber 32 are defined in the body 30b of the control cylinder 30, on either side of the piston 30a, which incorporates seals. The first chamber 31 (or upper chamber) is called “high-pressure chamber” because it takes up the combustion forces; in contrast, the second chamber 32 (or lower chamber) is called the “low-pressure chamber.” The respective filling and emptying of the first 31 and the second 32 chambers modify the length of the control cylinder 30.

The body 30b of the control cylinder 30 comprises two coaxial side bearings 35 with a transverse axis T normal to the longitudinal axis L (FIG. 6b). These side bearings 35 are intended to establish a pivot connection with a part of the engine (either stationary, secured to the engine block, or mobile, depending on the integration configuration of the hydraulic control system 3 in the engine). The lateral position of the side bearings 35 makes it possible to compact the control cylinder 30 with respect to a conventional cylinder with the connection points at the ends, thus limiting the size in the engine block. Advantageously, each lateral bearing 35 has a shoulder 35a to ensure the positioning of the cylinder 30, along the transverse axis T, in the engine.

The control cylinder 30 comprises a spacer 52 attached to each side bearing 35 and intended to be secured to the aforementioned part of the engine (FIG. 6c). The connection between the side bearings 35 and the added spacers 52 allows the oscillating movement of the control cylinder 30 that is necessary for the operation of the control system 3 in the engine 100. To this end, each added spacer 52 has a cylindrical internal housing, to accommodate a side bearing 35. The outer enclosure of the spacer 52 may also be cylindrical. It may nevertheless be advantageous to provide an ovoid outer enclosure to block any rotational movement of the spacer 52 with respect to the part of the engine to which it is attached. Provision can also be made for the internal housing accommodating a side bearing 35 to be eccentric with respect to the central axis of the outer enclosure of the added spacer 52, which will be chosen in this case as cylindrical or ovoid: this also provides an anti-rotation function.

The control cylinder 30 comprises a stepped ring 53 inserted between each side bearing 35 and its attached spacer 52, to limit the friction associated with the oscillating movement of the control cylinder 30 and to partially take up the combustion forces as well as the inertia forces experienced by the cylinder 30.

The fluid discharging device 372 of the hydraulic control circuit 37 comprises a first hydraulic slide valve 372b and a second hydraulic slide valve 372c, respectively, housed in the first side bearing 35 and the second side bearing 35 of the cylinder 30 (FIG. 6d). Preferably, the two slide valves are arranged along the transverse axis T, coaxially with the side bearings 35.

A movement along the transverse axis T of the first hydraulic slide valve 372b makes it possible, for example, to establish an oil circulation (schematized by the black arrows in FIG. 6d) from the first chamber 31 to the second chamber 32, via first passages 37b arranged in the body 30b of the cylinder 30. In practice, the movement of the first slide valve 372b puts the first passages 37b leading to the two chambers 31, 32 into communication, and a first non-return valve 372b′ is arranged on the first passages 37b, only allowing circulation of fluid from the first chamber 31 to the second chamber 32 (FIG. 6e, (i), (ii)).

A movement of the second hydraulic slide valve 372c makes it possible to establish a circulation of oil from the second chamber 32 to the first chamber 31, via second passages 37c arranged in the body 30b. In practice, the movement of the second slide valve 372c puts the second passages 37c leading to the two chambers 31, 32 into communication, and a second non-return valve 372c′ is arranged on the second passages 37c, only allowing a circulation of fluid from the second chamber 32 to the first chamber 31.

To generate the movement of the hydraulic slide valves 372b, 372c, the system 3 implements a hydraulic control circuit 80. The control circuit 80 is supplied by a pressurized fluid (for example, oil) coming from the part of the engine to which the body 30b is connected.

In the example illustrated in FIG. 6d, the hydraulic slide valves 372b, 372c are actuated mechanically. Such an option can be advantageous in that it avoids sometimes complex management of the sealing between stationary and moving parts or between two moving parts in the engine. To this end, each hydraulic slide valve 372b, 372c is intended to be in contact via a ball 803 with a control piston 801, 802 carried by the added spacer 52 (FIG. 6c (ii), FIG. 6d).

Each control piston 801, 802 can be moved by the oil pressure (shown schematically by the white arrows in FIG. 6e) in the control circuit 80, to induce the movement of the associated hydraulic slide valve 372b, 372c. The oil from this circuit 80 is conveyed via fluid channel 81 to an internal housing of each added spacer 52, which housing accommodates the control piston 801, 802.

The mechanical contact between the control piston 801, 802 and the hydraulic slide valve 372b, 372c is ensured by a ball 803, which is capable of accommodating the oscillation of the cylinder 30 with respect to the other parts in connection with the engine, including, in particular, with respect to the control piston 801, 802. This configuration provides a simple and robust solution for external control of the hydraulic control circuit 37 of the system 3.

The hydraulic control circuit 37 comprises at least one duct 37d and a refill valve 373, between an oil supply and the lower chamber 32 (FIG. 6e (i), (iii)). The refill valve 373 is configured so as to allow oil to circulate from the oil supply to the second chamber 32, when the pressure in the chamber 32 is lower than the supply pressure.

The hydraulic control circuit 37 comprises at least one duct 37e and a relief valve 374 between the second hydraulic chamber 32 and the outside of the cylinder 30, so as to discharge oil from the hydraulic control circuit 37, when the pressure in the chamber 32 exceeds a determined maximum pressure. It is, for example, possible to choose a relief valve 374 whose opening pressure is greater than 200 bars or 300 bars, so as to avoid implementing complex sealing solutions in the hydraulic control system 3.

The hydraulic control system 3, and, in particular, the system 3 according to the aforementioned embodiment, is particularly suitable for integration into a variable compression ratio engine of the VCT type.

This type of VCT engine, a prior art embodiment of which is illustrated in FIG. 7, comprises two distinct groups of components:
The mobile coupling 1 integrating the combustion pistons 10, the main connecting rods 11, the return members 12 and the crankshaft 13,
The control system 3 integrating the control rods 20, the eccentric shaft 22, the levers 23, 25, the connecting rod 24 and the electrical control means 26.

The hydraulic control system 3 according to the present disclosure can replace the aforementioned control system 3, as illustrated in FIG. 8. In this use, the piston 30a of the control cylinder 30 is intended to be connected, via its foot 30a′, to a return member of a mobile coupling of the engine, and the body 30b of the control cylinder 30 is intended to be connected to a stationary part 51 of the engine.

The hydraulic control system 3 in accordance with the present disclosure, for a variable compression ratio engine, comprises one or more control cylinder(s) 30 as previously described. The mobile coupling 1 of the engine 100 of the VCT type, integrating the combustion pistons 10, the main connecting rods 11, the return members 12 and the crankshaft 13, can remain unchanged, as can the upper part of the engine. The shape of the control cylinders 30 is designed to fit into the current size of the engine, thus avoiding increasing the center distance of the engine 100.

Naturally, the present disclosure is not limited to the embodiments and to the examples described, and it is possible to make variants of the embodiments without departing from the scope of the invention as defined by the claims.

1. A hydraulic control system for a variable compression ratio engine, comprising:
a control cylinder comprising a piston and a body in which two hydraulic chambers with equivalent sections are defined on either side of the piston, the piston being able to move in the body to control the compression ratio of the engine;
a hydraulic control circuit comprising:
* at least one duct connecting the two hydraulic chambers to each other, and a controlled fluid discharging device to establish or block a fluid communication between the chambers;
* at least one duct connecting at least one of the hydraulic chambers and a low-pressure oil supply, between 2 and 6 bars, and a first non-return valve, to refill the hydraulic control circuit when the pressure in the hydraulic chamber drops below the low pressure, due to combustion and/or engine inertia forces applied to the cylinder;
* at least one duct connecting at least one of the hydraulic chambers and an oil outlet, and a relief valve for draining the hydraulic control circuit when the pressure in the hydraulic chamber exceeds a determined maximum pressure; and
the control cylinder comprises a return device tending to bring the cylinder back to a length corresponding to a maximum compression ratio of the engine.

2. The hydraulic control system according to claim 1, wherein the duct fitted with the relief valve connects the oil outlet and the chamber, among the two hydraulic chambers, that is not subjected to the combustion forces of the engine.

3. The hydraulic control system of claim 1, wherein the return device is arranged in the chamber, among the two hydraulic chambers, that undergoes engine combustion forces.

4. The hydraulic control system of claim 1, wherein the hydraulic control circuit is carried by the body of the control cylinder.

5. The hydraulic control system of claim 1, wherein the controlled fluid discharging device is actuated by an electrical control circuit.

6. The hydraulic control system of claim 1, wherein the controlled fluid discharging device is actuated by a hydraulic control circuit.

7. The hydraulic control system of claim 1, wherein the fluid discharging device comprises a two-position controlled shutter, one position of which blocks fluid communication between the two chambers and the other position allows fluid communication between the two chambers, in both directions of circulation.

8. The hydraulic control system of claim 1, wherein the hydraulic control circuit comprises at least two ducts connecting the two hydraulic chambers to each other, and in which the fluid discharging device comprises two controlled shutters with two positions and two oriented valves, a first shutter and a first oriented valve being carried by a first duct, to block or authorize the circulation of oil from the first chamber to the second chamber, and a second shutter and a second oriented valve being carried by a second duct, to block or authorize the circulation of oil from the second chamber to the first chamber.

9. The hydraulic control system of claim 8, wherein each controlled shutter is arranged along a transverse axis, normal to a longitudinal movement axis of the piston in the body of the control cylinder.

10. The hydraulic control system of claim 1, wherein:
* the piston of the control cylinder is configured to be connected to a return member of a mobile coupling of the engine; and
* the body of the control cylinder is configured to be connected to a stationary part of the engine.

11. The hydraulic control system of claim 2, wherein the return device is arranged in the chamber, among the two hydraulic chambers, that undergoes engine combustion forces.

12. The hydraulic control system of claim 11, wherein the hydraulic control circuit is carried by the body of the control cylinder.

13. The hydraulic control system of claim 12, wherein the controlled fluid discharging device is actuated by an electrical control circuit.

14. The hydraulic control system of claim 12, wherein the controlled fluid discharging device is actuated by a hydraulic control circuit.

15. The hydraulic control system of claim 13, wherein the fluid discharging device comprises a two-position controlled shutter, one position of which blocks fluid communication between the two chambers and the other position allows fluid communication between the two chambers, in both directions of circulation.

16. The hydraulic control system of claim 6, wherein the hydraulic control circuit comprises at least two ducts connecting the two hydraulic chambers to each other, and in which the fluid discharging device comprises two controlled shutters with two positions and two oriented valves, a first shutter and a first oriented valve being carried by a first duct, to block or authorize the circulation of oil from the first chamber to the second chamber, and a second shutter and a second oriented valve being carried by a second duct, to block or authorize the circulation of oil from the second chamber to the first chamber.

17. The hydraulic control system of claim 7, wherein each controlled shutter is arranged along a transverse axis, normal to a longitudinal movement axis of the piston in the body of the control cylinder.

18. The hydraulic control system of claim 1, wherein:
the piston of the control cylinder is configured to be connected to a return member of a mobile coupling of the engine; and
the body of the control cylinder is configured to be connected to a stationary part of the engine.
